(19) United States
(12) Patent Application Publication
(10) Pub. No.: US 2019/0149763 A1
(43) Pub. Date: May 16, 2019

(54) ACCIDENT DETECTION SYSTEM AND METHOD

(71) Applicant: Linda Ponder, Lumpkin, GA (US)

(72) Inventor: Linda Ponder, Lumpkin, GA (US)

(21) Appl. No.: 15/983,011

(22) Filed: May 17, 2018

Related U.S. Application Data
(60) Provisional application No. 62/584,685, filed on Nov. 10, 2017.

(51) Int. Cl. H04N 5/77; H04N 7/18; G01P 3/50; B60R 21/0132; B60R 16/033

(52) U.S. Cl. CPC H04N 5/77; H04N 7/181; G01C 19/00; B60R 21/0132; B60R 16/033; G01P 3/50

(57) ABSTRACT

A system for detecting accidents; the system may include a sensor configured to detect a motion of the automobile from a resting state. The system also includes a plurality of cameras configured to capture an image a predetermined proximity from a vehicle. The plurality of cameras are actuated through wireless communication with the sensor. A controller is in wireless communication with the sensor and the plurality of cameras and configured to receive and store an image from the plurality of cameras. The system may be designed to take a recording of all parties involved in an automobile collision.

### CROSS REFERENCE TO RELATED APPLICATION

The present application is related to and claims priority to U.S. Provisional Patent Application No. 62/584,685 filed 2017 Nov. 10, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of accident detection means and more specifically relates to a system for accident detection.

### 2. Description of Related Art

A hit and run crime is the act of causing or contributing to a traffic accident and failing to follow through the proper means of reporting the incident. In instances of hit and run accidents, at least one party fails to identify themselves. Typically, the offending party will flee the scene of the accident and offer no information regarding what has occurred. Many hit and run accidents involve parked cars, stopped cars, and empty idling cars. An offending vehicle will in some way impact a vehicle that is unattended and then flee the scene to avoid paying reparations for the damages. Means of protecting unattended vehicles have been explored, including car alarms and video cameras. Many of these solutions have proven to be ineffective or cost prohibitive.

U.S. Pub. No. 2012/0286974 to Heiko Claussen relates to a hit and run prevention and documentation system for vehicles. The described hit and run prevention and documentation system for vehicles includes systems and methods that warn approaching vehicles that pose a collision threat and document the occurrence of a collision. Embodiments use vehicle proximity sensors in conjunction with vehicle video cameras to detect an approaching object, determine the likelihood of collision and if likely, record video data.

### BRIEF SUMMARY OF THE INVENTION

In view of the foregoing disadvantages inherent in the known accident detection means art, the present disclosure provides a novel accident detection system and method. The general purpose of the present disclosure, which will be described subsequently in greater detail, is to provide an efficient and effective accident detection system.

A system is disclosed herein. The system includes a sensor configured to detect a motion of the automobile from a resting state. The system also includes a plurality of cameras configured to capture an image a predetermined proximity from a vehicle. The plurality of cameras is/are actuated through wireless communication with the sensor. A controller is in wireless communication with the sensor and the plurality of cameras and is configured to receive and store an image from the plurality of cameras. The system may be designed to take a recording of all parties involved in an automobile collision.

A method of using the accident detection system is also disclosed herein. The method of using the system may comprise the steps of: providing a system for accident detection; the system may comprise a sensor; the sensor configured to detect a motion of the automobile from a resting state, a plurality of cameras; the plurality of cameras configured to capture an image a predetermined proximity from a vehicle. The plurality of cameras is actuated through wireless communication with the sensor, and, a controller; the controller in wireless communication with the sensor and the plurality of cameras. The controller is configured to receive and store an image from the plurality of cameras, wherein the system may be designed to take a recording of all parties involved in an automobile collision; installing the system to the automobile; activating the system to the active-state with the toggle button; the method further may comprise the step of reviewing the image and video captured by the plurality of cameras;

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an accident detection system and method, constructed and operative according to the teachings of the present disclosure.

FIG. 1 is a side perspective view of the system during an ‘in-use’ condition, according to an embodiment of the disclosure.

FIG. 2 is another view of the system of FIG. 1, according to an embodiment of the present disclosure.

FIG. 3 is a rear perspective view of the system of FIG. 1, according to an embodiment of the present disclosure.

FIG. 4 is a flow diagram view of the system of FIG. 1, according to an embodiment of the present disclosure.

FIG. 5 is a flow diagram illustrating a method of use for the system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a system and more particularly to an accident detection system and method as used to improve the means for accident detection.

Generally, the present invention provides an automobile with a sensor and camera system capable of detecting collisions with an unattended automobile. It may feature a sensor that may be attached to an automobile that is capable of identifying collision situations. The system may feature cameras designated to record when activated by the sensor. The cameras may be configured to record an area within a define proximity of the automobile. The cameras may be configured to record any party involved in a collision with an unattended vehicle. The system may also store the images captured and report the images to a user through their mobile device or an online storage medium.

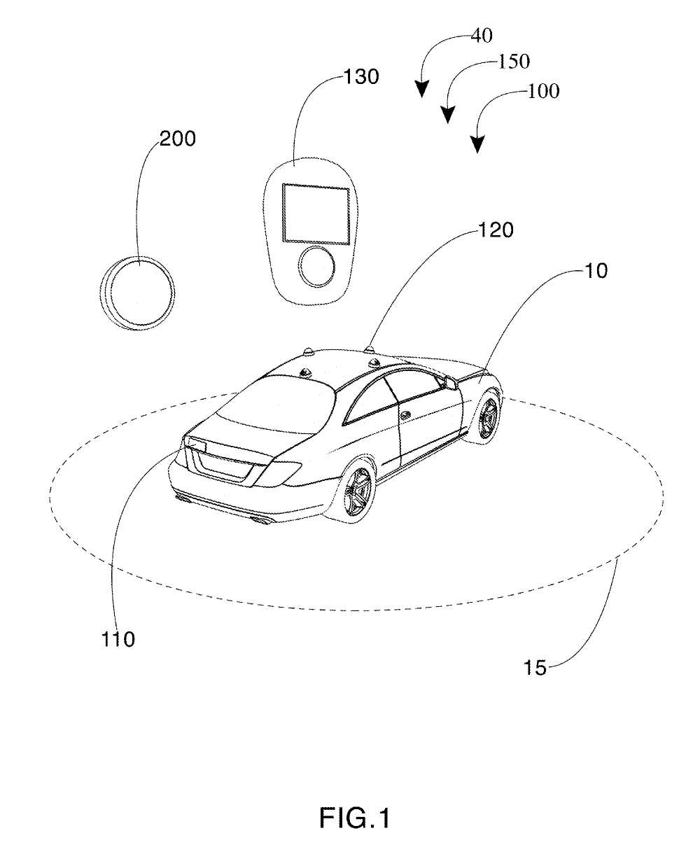

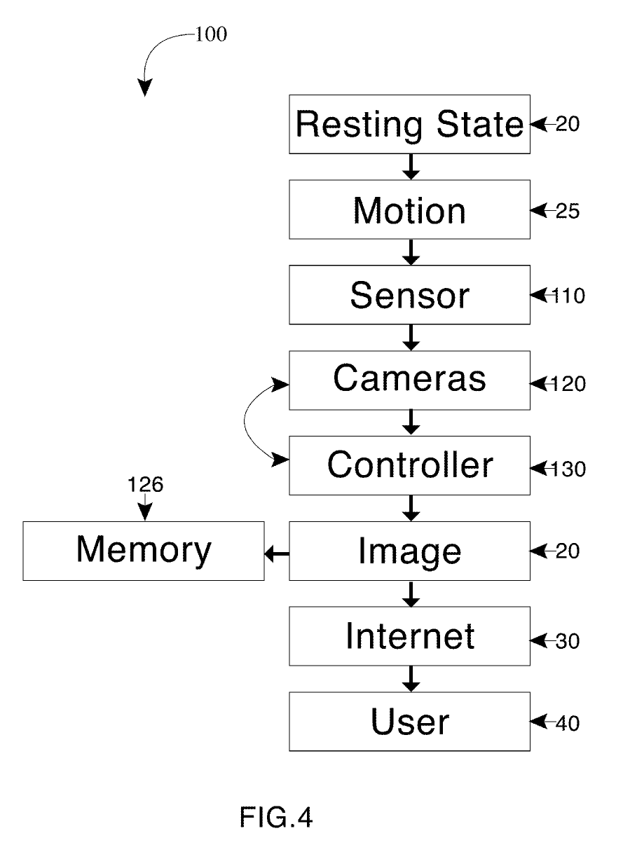

Referring now more specifically to the drawings by numerals of reference, there is shown in FIGS. 1-5, various views and flow diagrams of a system 100. FIG. 1 shows a system 100 during an ‘in-use’ condition 150, according to an embodiment of the present disclosure. As Illustrated, the system 100 may include a sensor 110 configured to detect a motion 20 (FIG. 4) of the automobile 10 from a resting state 25 (FIG. 4). The resting state 25 of the automobile 10 may be any state where the system is enabled. A user 40 may enable the system when the car is in any situation where the car is left unattended, or when the user 40 is present. A plurality of cameras 120 may be configured to capture an image a predetermined proximity 15 from an automobile 10. The plurality of cameras 120 may further be configured to capture video of the predetermined proximity 15 from the automobile 10. The predetermined proximity 15 may be adjustable to extend farther or nearer from the automobile 10. The predetermined proximity 15 may define the distance that the plurality of cameras 120 may capture images from.

The plurality of cameras 120 may be actuated through wireless communication with the sensor 110. The wireless communication may include radio signals and electromagnetic wireless technologies. The controller 130 may be in wireless communication with the sensor 110 and the plurality of cameras 120. Wireless communication between the controller 130 and the sensor 110 may use radio or other electromagnetic wireless technologies. The controller 130 may be configured to receive and store an image from the plurality of cameras 120. The controller 130 may store the image through a memory 126 (FIG. 4) configured to store the image and video captured by the plurality of cameras 120. The memory 126 may be any machine readable storage medium including removable media having the ability to store the captured image and video such as compact disks, and flash memory. The system further includes a toggle button 200 configured to enable the system to an active-state and a deactivated state. The system may be designed to take a recording of all parties involved in an automobile 10 collision.

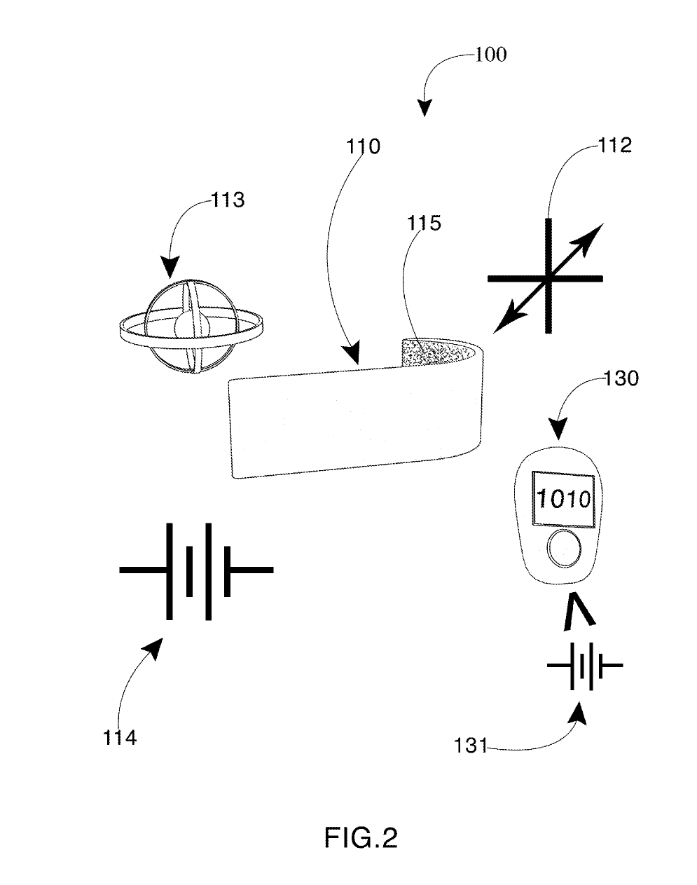

FIG. 2 shows a front perspective view of the system 100 of FIG. 1, according to an embodiment of the present disclosure. As above, the system 100 may include a sensor 110. The sensor 110 may include at least one accelerometer device 112. The accelerometer device 112 may be configured to measure linear acceleration of the motion 20 (FIG. 4). The accelerometer device 112 may be replaced by any other device of similar functionality. The sensor 110 may further include a gyroscopic sensor 113 configured to provide information to the controller 130. The gyroscopic sensor 113 may be configured to collect information regarding direction of motion 20 for reporting to the controller 130. The sensor 110 further includes an energy source 114. The energy source 114 may embody a battery, photovoltaic cells, piezoelectric crystals and any further conceived source of energy. The sensor 110 may further draw energy from the automobile 10 (FIG. 1). The controller 130 may also include a control-energy-source 131 configured to power the controller 130. The control-energy-source 131 may further draw power from the automobile 10 to power the controller 130. The sensor 110 may include an adhesive backing 115. The adhesive backing 115 may allow the sensor 110 to be disposed on the automobile 10.

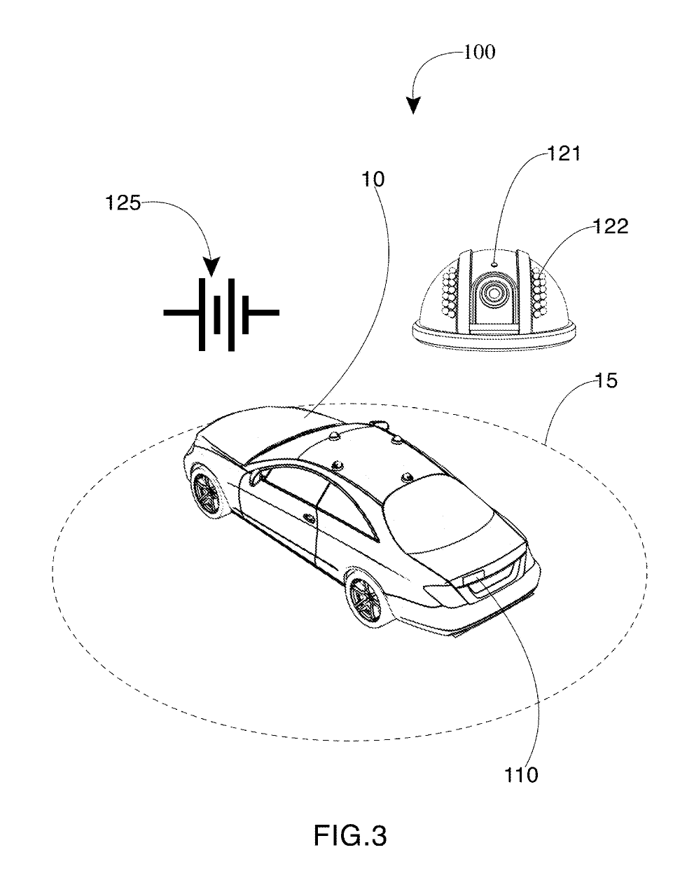

Referring now to FIG. 3 showing a rear perspective of the system 100 of FIG. 1, according to an embodiment of the present disclosure. As above, the system 100 may include a sensor 110, a controller 130 (FIG. 2) and a plurality of cameras 120 (FIG. 1). The plurality of cameras 120 may be configured to capture video. The plurality of cameras 120 may be disposed on the automobile 10 as pictured. Further configurations of placement of the plurality of cameras 120 are considered. The plurality of cameras 120 may include proximity sensors 121. The proximity sensors 121 may be configured to sense external motion to the automobile 10 within the predetermined proximity 15. The plurality of cameras 120 may include infrared lights 122 configured to illuminate the predetermined proximity 15 when activated. The plurality of cameras 120 further includes a camera-energy-source 125 configured to power the plurality of cameras 120. The camera-energy-source 125 may include a battery, photovoltaic cells, and any further conceived source of energy that may be used to power the plurality of cameras 120. The plurality of cameras 120 may be wired to the controller 130.

FIG. 4 shows a flow diagram of the system 100 of FIG. 1, according to an embodiment of the present disclosure. As above, the system 100 may include a sensor 110 in communication with a wireless controller 130 that activates a plurality of cameras 120 when the automobile 10 experiences motion 20 from a resting state 25. The controller 130 may be configured with an internet 30 connectivity; the internet 30 connectivity including: Wi-Fi, CDMA (code division multiple access), GSM (global system for mobiles) and further conceived internet 30 connection systems. The controller 130 further includes a memory 126 configured to store the image and video captured by the plurality of cameras 120. In a further embodiment, the controller 130 may be configured to alert a user 40 of the motion 20 of the automobile 10 from the resting state 25 through the internet 30 connectivity. In another embodiment of the system 100, the motion 25 of the automobile 10 from a resting state 20 may cause the sensor 110 to activate the controller 130 that in turn activates the plurality of cameras 120.

According to one embodiment, the system 100 may be arranged as a kit. The kit may include instructions. The instructions may detail functional relationships in relation to the structure of the system 100 (such that the system 100 can be used, maintained, or the like, in a preferred manner).

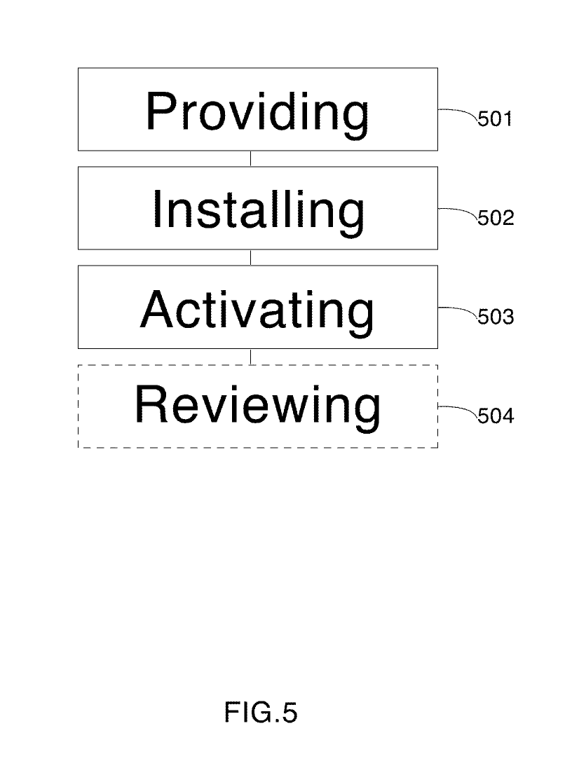

Referring now to FIG. 5, a flow diagram 550 illustrating a method for installing a system for accident detection 500, according to an embodiment of the present disclosure. As illustrated, the method for installing a system for accident detection 500 may include the steps of: step 501, providing a system for accident detection, the system may comprise a sensor, the sensor configured to detect a motion of the automobile from a resting state, a plurality of cameras, the plurality of cameras configured to capture an image a predetermined proximity from a vehicle, the plurality of cameras actuated through wireless communication with the sensor, and, a controller, the controller in wireless communication with the sensor and the plurality of cameras, the controller configured to receive and store an image from the plurality of cameras, wherein the system may be designed to take a recording of all parties involved in an automobile collision; step 502, installing the system to the automobile; step 503 activating the system to the active-state with the toggle button; and further may comprise step 504, reviewing the image and video captured by the plurality of cameras.

It should be noted that step 504 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for system 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A system for accident detection and recording for an automobile, the system comprising:
a sensor, the sensor configured to detect a motion of the automobile from a resting state;
a plurality of cameras, the plurality of cameras configured to capture an image a predetermined proximity from an automobile, the plurality of cameras actuated through wireless communication with the sensor;
a controller, the controller in wireless communication with the sensor and the plurality of cameras, the controller configured to receive and store an image from the plurality of cameras;
wherein the system is designed to take a recording of all parties involved in an automobile collision.

2. The system of claim 1, wherein the sensor includes at least one accelerometer device configured to measure linear acceleration of the motion.

3. The system of claim 1, wherein the sensor includes a gyroscopic sensor configured to provide information to the controller.

4. The system of claim 1, wherein the sensor further includes an energy source.

5. The system of claim 1, wherein the sensor includes an adhesive backing.

6. The system of claim 1, wherein the plurality of cameras are configured to capture a video.

7. The system of claim 1, wherein the plurality of cameras include proximity sensors.

8. The system of claim 6, wherein the plurality of cameras include infrared lights configured to illuminate the predetermined proximity when activated.

9. The system of claim 1, wherein the system further includes a toggle button configured to enable the system to an active-state and a deactivated state.

10. The system of claim 1, wherein the controller is configured with an internet connectivity, the internet connectivity including: Wi-fi, CDMA (code Division Multiple Access), GSM (Global System for Mobiles) and further conceived internet connection systems.

11. The system of claim 10, wherein the controller further includes a memory configured to store the image and the video captured by the plurality of cameras.

12. The system of claim 1, wherein the controller is configured to alert a user of the motion of the automobile from the resting state through the internet connectivity.

13. The system of claim 1, wherein the plurality of cameras further includes a camera-energy-source configured to power the plurality of video cameras.

14. The system of claim 1, wherein the controller further includes a control-energy-source configured to power the controller.

15. The system of claim 1, wherein the controller is configured to draw electricity from a battery of the automobile.

16. The system of claim 1, wherein the plurality of cameras is wired to the controller.

17. A system for accident detection, the system comprising:
a sensor, the sensor configured to detect a motion of the automobile from a resting state,
a plurality of cameras, the plurality of cameras configured to capture an image a predetermined proximity from a automobile, the plurality of cameras actuated through wireless communication with the sensor,
a controller, the controller in wireless communication with the sensor and the plurality of cameras, the controller configured to receive and store an image from the plurality of cameras,
wherein the system is designed to take a recording of all parties involved in an automobile collision;
wherein the sensor includes at least one accelerometer device configured to measure linear acceleration of the motion;
wherein the sensor includes a gyroscopic sensor configured to provide information to the controller;
wherein the sensor further includes an energy source;
wherein the sensor includes an adhesive backing;
wherein the plurality of cameras are configured to capture a video;
wherein the plurality of cameras include proximity sensors;
wherein the plurality of cameras include infrared lights configured to illuminate the predetermined proximity when activated;
wherein the system further includes a toggle button configured to enable the system to an active-state and a deactivated state;
wherein the controller is configured with an internet connectivity, the internet connectivity including: Wi-fi, CDMA (Code Division Multiple Access), GSM (Global System for Mobiles) and further conceived internet connection systems;
wherein the controller further includes a memory configured to store the image and the video captured by the plurality of cameras;
wherein the controller is configured to alert a user of the motion of the automobile from the resting state through the internet connectivity;
wherein the plurality of cameras further includes a camera-energy-source configured to power the plurality of video cameras;
wherein the controller further includes a control-energy-source configured to power the controller;
wherein the controller is configured to draw electricity from a battery of the automobile; and
wherein the plurality of cameras is wired to the controller;

18. The system for accident detection of claim 17, further comprising set of instructions; and
wherein the system is arranged as a kit.

19. A method for installing a system for accident detection, the method comprising the steps of:
providing a system for accident detection, the system comprising a sensor, the sensor configured to detect a motion of the automobile from a resting state,
a plurality of cameras, the plurality of cameras configured to capture an image a predetermined proximity from a automobile, the plurality of cameras actuated through wireless communication with the sensor, and,
a controller, the controller in wireless communication with the sensor and the plurality of cameras, the controller configured to receive and store an image from the plurality of cameras,
wherein the system is designed to take a recording of all parties involved in an automobile collision;
installing the system to the automobile;
activating the system to the active-state with the toggle button;

20. The method of claim 19, further comprising the steps of:
reviewing the image and the video captured by the plurality of cameras;
